(19) United States
(12) Patent Application Publication
(10) Pub. No.: US 2010/0328363 A1
(43) Pub. Date: Dec. 30, 2010

(54) INFORMATION PROCESSING APPARATUS AND METHOD FOR CONTROLLING LUMINANCE

(75) Inventor: Wataru NAKANISHI, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/792,669

(22) Filed: Jun. 2, 2010

(30) Foreign Application Priority Data
Jun. 30, 2009 (JP) 2009-155251

(51) Int. Cl. G09G 5/10

(52) U.S. Cl. 345/690; 345/87

(57) ABSTRACT

An information processing apparatus includes: a display device having a display screen being divided into a plurality of divisional areas, each of which being controlled to have individual luminance; a target area determining module configured to determine, as a target area, a group of divisional areas to which a drawing region where at least one of an active window and a cursor is drawn belongs; and a luminance controller configured to control luminance of the respective divisional areas of the display screen independently so that the target area has a first luminance and the other divisional areas have a second luminance that is lower than the first luminance.

### CROSS REFERENCE TO RELATED APPLICATION(S)

The present disclosure relates to the subject matters contained in Japanese Patent Application No. 2009-155251 filed on Jun. 30, 2009, which are incorporated herein by reference in its entirety.

### FIELD

The present invention relates to an information processing apparatus and a method for controlling luminance of a display device.

### BACKGROUND

Various techniques for controlling the luminance of a display device are known. An example of such technique is disclosed in JP-A-2008-242009.

The information processing apparatus disclosed in the publication, JP-A-2008-242009, is capable of controlling the intensity of illumination light for each of divisional areas of the display screen of a display device. Luminance data for each screen area (e.g., an average luminance value for each area) is calculated from data of an image to be displayed and the intensity of illumination light for each screen area is determined based on the corresponding luminance data thus-determined. Capable of controlling the luminance for each screen area based on image data, the information processing apparatus can increase the user visibility by widening the contrast dynamic range by increasing the brightness in areas where image data has large luminance values and decreasing the brightness in areas where the image data has small luminance values.

However, the above conventional technique may lower the convenience of the user if a region to which the user pays attention does not coincide with a region where image data has large luminance values. In the conventional technique, illumination light intensity values for the respective screen areas are determined according to luminance data, corresponding to the respective screen areas, of an image to be displayed. As a result, if, for example, a wallpaper image (background image) of an image to be displayed is less important to the user and it is very high in luminance because it is white, the illumination light intensity is made higher in screen areas where the background image is drawn than in screen areas where an image of an active window is drawn which is more important to the user and to which the user pays attention. In this case, the visibility of the active window which is more important to the user is low and the convenience of the user is thus lowered.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 shows a general configuration of a personal computer according to an embodiment of the invention.

FIG. 2 is a block diagram outlining an example internal configuration of the personal computer

FIG. 3 illustrates a corresponding relationship between individual areas of the display screen of an LCD and light sources of a backlight.

FIG. 4 illustrates an example corresponding relationship between the individual areas of the display screen and groups of sets of screen coordinates.

FIG. 5 illustrates an example corresponding relationship between the screen areas and an active window and a cursor which are displayed on the display screen.

FIG. 6 is a block diagram outlining an example configuration of CPU function implementing modules of a controller.

FIG. 7 is a flowchart of a procedure according to which a main controller of the personal computer controls the luminance for each screen area while securing high convenience of the user by keeping the visibility high in a target area.

### DETAILED DESCRIPTION OF THE EMBODIMENTS

An information processing apparatus and a luminance control method according to an embodiment of the present invention will be hereinafter described with reference to the accompanying drawings.

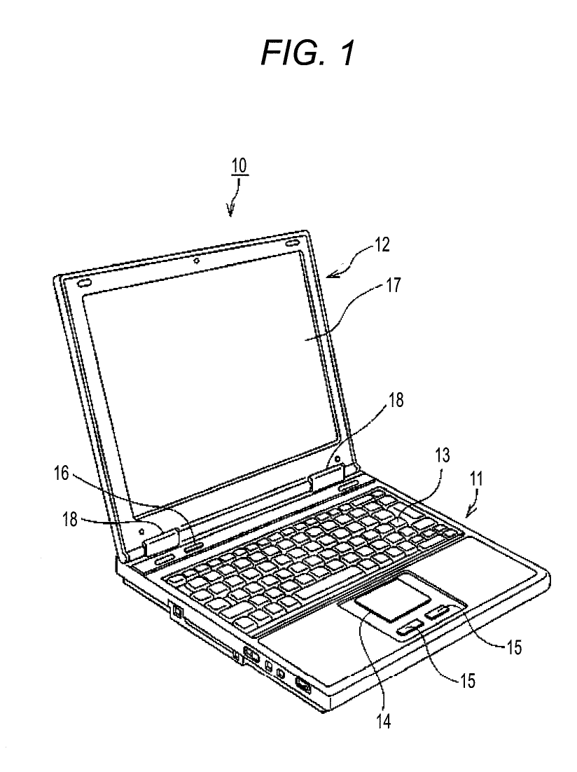

FIG. 1 shows a general configuration of the entire image processing apparatus according to the embodiment of the invention.

The invention can be applied to an information processing apparatus capable of controlling the intensity of illumination light for each of divisional areas of the display screen of a display device. The embodiment is directed to a notebook personal computer (hereinafter referred to as “personal computer”) which is an example information processing apparatus according to the invention.

As shown in FIG. 1, the personal computer 10 is equipped with a main unit 11 and a display unit 12 as a display device.

The main unit 11 has a thin, box-shaped body, and a central portion of the top surface of the body is provided with a keyboard 13. A user-side portion of the top surface of the body of the main unit 11 is formed with a palm rest.

A touch pad 14 and touch pad control buttons 15 are provided in an approximately central portion of the palm rest. A power button 16 for powering on/off the personal computer 10 is disposed at a rear position on the top surface of the body of the main unit 11.

The display unit 12 has a display panel 17 as the display device and is connected to the main unit 11 by connection members (hinges) 18 which support the display unit 12 so that it can be opened and closed.

The following description will be directed to a case that the display device is a liquid crystal display device. However, the invention can also be applied to a case that the display device is an OLED (organic light-emitting diode) display.

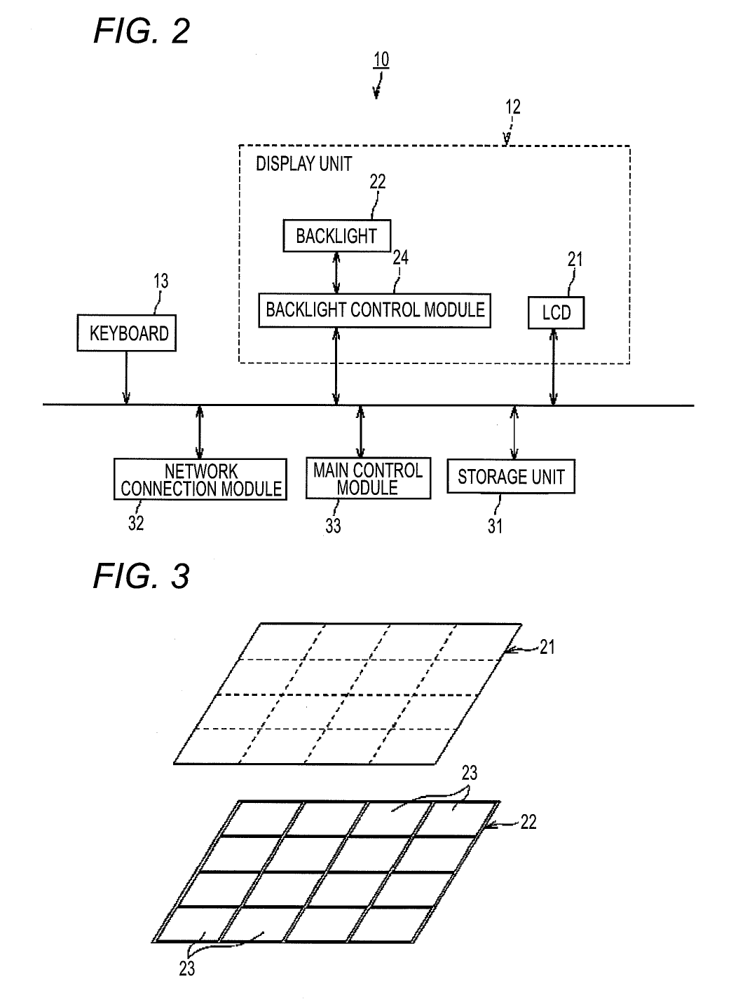

FIG. 2 is a block diagram outlining an example internal configuration of the personal computer 10.

As shown in FIG. 2, the personal computer 10 is equipped with a storage unit 31, a network connection interface 32, and a main controller 33 in addition to the keyboard 13 and the display unit 12.

The keyboard 13 outputs a manipulation input signal corresponding to a user manipulation to the main controller 33.

The display panel 17 of the display unit 12 incorporates an LCD (liquid crystal display, liquid crystal display panel) 21 which provides a display screen and a backlight 22 as light sources. The backlight 22 consists of plural light sources 23. The display unit 12 has a backlight controller 24.

FIG. 3 illustrates a corresponding relationship between individual areas of the display screen and the light sources 23 of the backlight 22. In FIG. 3, broken lines shown in the LCD 21 are imaginary lines indicating the boundaries between the screen areas.

The LCD 21 displays various types of information on the display screen under the control of the main controller 33. The display screen of the LCD 21 is divided into the plural areas in advance. As shown in FIG. 3, the light sources 23 of the backlight 22 illuminate the respective divisional areas of the display screen of LCD 21 from behind.

FIG. 3 shows a case that each screen area is illuminated by one light source 23 which is a surface light surface. However, each light source 23 is not limited to a surface light source and may be a point light source. As a further alternative, each screen area may be illuminated with plural light sources. Furthermore, the method for illuminating the LCD 21 is not limited to the backlight method and may be a side light method as long as the luminance can be controlled for each screen area.

The emission luminance of each light source 23 of the backlight 22 is controlled by the backlight controller 24. The backlight controller 24 is configured so as to be able to independently control the luminance values of the light sources 23 of the backlight 22 so that the light sources 23 emit light at respective luminance values as commanded by the main controller 33.

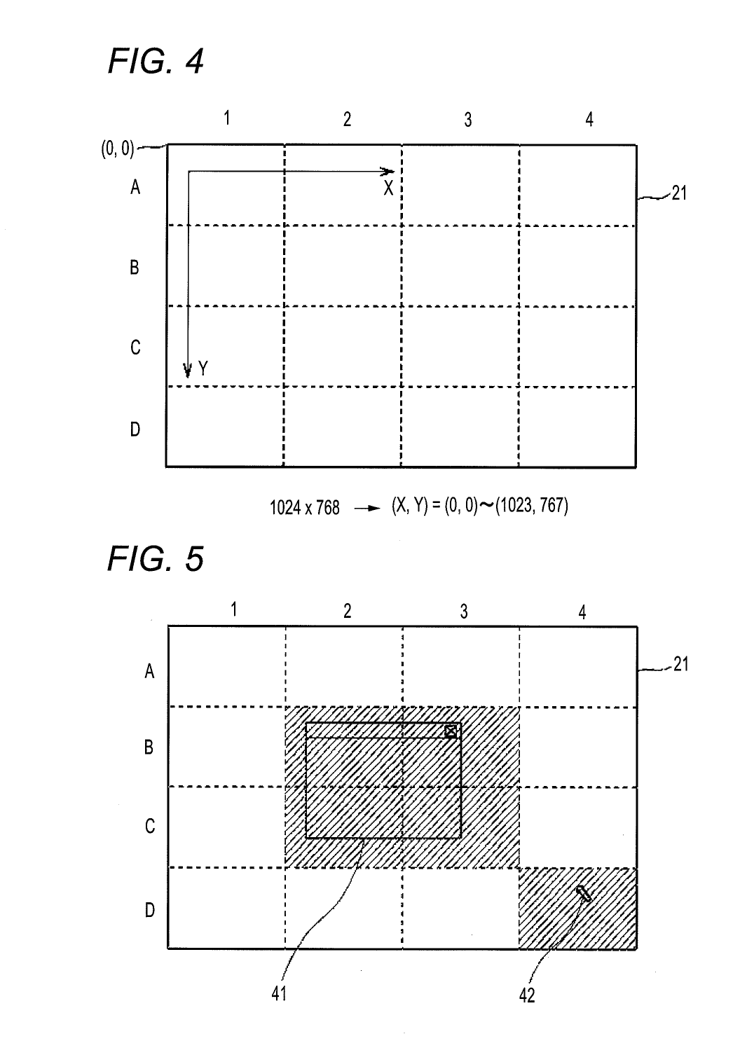

FIG. 4 illustrates an example corresponding relationship between the individual areas of the display screen and groups of sets of screen coordinates. FIG. 4 shows a case that the total number of pixels (hereinafter referred to as “display resolution”) used for display of one full picture is 1,024×768.

The screen coordinates are coordinates of a coordinate system in which the top-left corner of the screen is the origin (0, 0), the X-coordinate increases as the position goes right ward, and the Y-coordinate increases as the corresponding relationship between the individual areas of the display screen and the groups of sets of screen coordinates depends on the display resolution. On the other hand, the LCD 21 in many cases accommodates plural display resolutions such as 800×600, 1,024×768, and 1,280×1,024. Furthermore, in many cases, the display resolution can be changed arbitrarily by the user through a user interface such as the keyboard 13.

Therefore, to make luminance for screen areas where an image that is more important to the user is displayed higher than luminance for the other screen areas, it is necessary to hold, for each display resolution, a corresponding relationship between groups of sets of screen coordinates, the areas of the display screen, and the light sources 23 for illuminating the respective screen areas. These corresponding relationships are stored in the storage unit 31 in advance.

FIG. 5 illustrates an example corresponding relationship between the screen areas and an active window 41 and a cursor 42 which are displayed on the display screen. In FIG. 5, hatched screen areas B2, B3, C2, and C3 are screen areas where the active window 41 is drawn and a hatched screen area D4 is a screen area where the cursor 42 is drawn. In the following description, the screen areas where the active window 41 is drawn and the screen area where the cursor 42 is drawn are generically called “target area.”

The main controller 33 can receive sets of screen coordinates of the region where the active window 41 is drawn based on sets of client coordinates. The client coordinates are coordinates of a coordinate system in which the top-left corner of a client region is the origin. In general, a window is composed of a client region where the contents of the window are drawn, a frame, a title bar, etc. Therefore, the main controller 33 can receive sets of screen coordinates of the region where the active window 41 is drawn (i.e., the region occupied by the active window 41) based on screen coordinates of the origin of the client coordinate system and a size of the active window 41. The main controller 33 can receive, from the operating system, screen coordinates of the origin of the client coordinate system and a size of the active window 41 as well as sets of screen coordinates where the cursor 42 is drawn.

A brief description will be made of a procedure according to which the main controller 33 controls the luminance values of the light sources 23 so that a target area is made higher in luminance than the other screen areas.

First, the main controller 33 receives sets of screen coordinates where the active window 41 and the cursor 42 are drawn. Then, the main controller 33 receives, based on the information stored in the storage unit 31, information of screen areas (target area) to which the received sets of screen coordinates belong at a current display resolution. Then, the main controller 33 receives, based on the information stored in the storage unit 31, information of the light sources 23 that illuminate the screen areas thus recognized. Finally, the main controller 33 sets the luminance values of the thus-recognized light sources 23 higher than those of the other light sources 23. According to this procedure, the screen areas where the active window 41 and the cursor 42 are drawn can be made higher in luminance than the other screen areas.

The storage unit 31 includes a CPU-readable storage medium such as a magnetic or optical storage medium or a semiconductor memory. At least groups of sets of screen coordinates, areas of the display screen, and the light sources 23 for illuminating the respective screen areas are stored in the storage unit 31 in advance for the respective screen resolutions.

The network connection interface 32 incorporates various information communication protocols for respective network forms. The network connection interface 32 connects the personal computer 10 and another electric apparatus according to an appropriate one of those protocols. The connection may be an electric one via an electronic network. The term “electronic network” means a general information communication network utilizing the electric communication technology and includes a wireless/wired LAN (local area network), the Internet, a telephone communication network, an optical fiber communication network, a cable communication network, and a satellite communication network.

The main controller 33, which is composed of a CPU, storage media such as a RAM and a ROM, etc., controls the operations of the personal computer 10 according to programs stored in those storage media.

The CPU of the main controller 33 loads an area-by-area luminance control program and data necessary for execution of this program that are stored in the storage medium as typified by the ROM into the RAM, and executes, according to this program, a process for controlling the luminance for each screen area while securing high convenience of the user by keeping the visibility high in a target area that is more important to the user.

The RAM of the main controller 33 provides a work area for temporary storage of a program to be run by the CPU and necessary data.

The storage media such as the ROM of the main controller 33 are stored with an activation program of the personal computer 10, the operating system, the area-by-area luminance control program, and various data that are necessary for execution of those programs.

Each of the storage media such as the ROM includes a CPU-readable storage medium, such as a magnetic or optical storage medium or a semiconductor memory. All or part of the programs and data stored in those storage media may be ones downloaded over an electronic network.

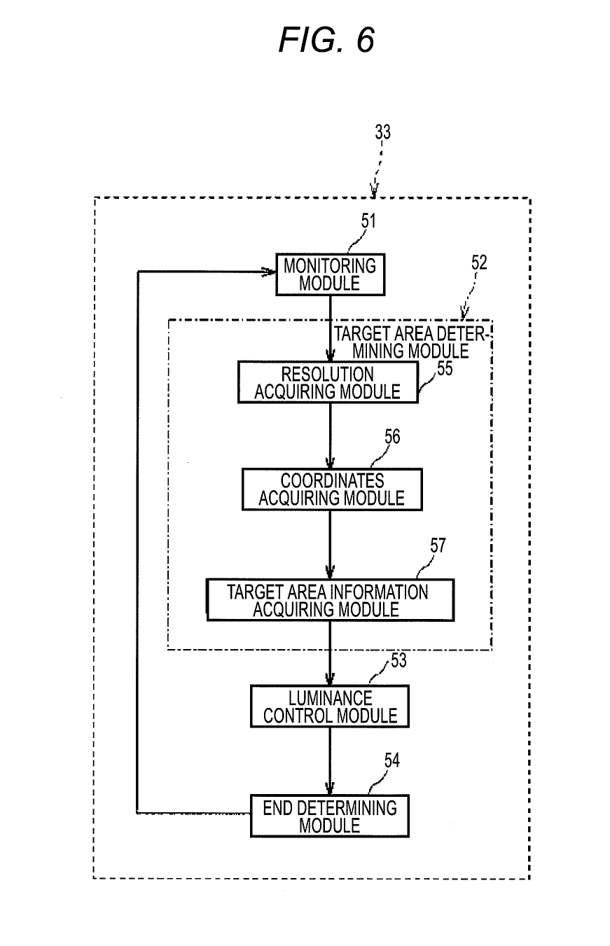

FIG. 6 is a block diagram outlining an example configuration of CPU function implementing sections of the main controller 33. Instead of using the CPU, the function implementing sections may be hardware logic sections such as circuits.

As shown in FIG. 6, by running the area-by-area luminance control program, the CPU of the main controller 33 functions at least as a monitoring module 51, a target area determining module 52, a luminance controller 53, and an end determining module 54. The modules 51-54 use work areas of the RAM as temporary data storage areas.

The monitoring module 51 monitors whether or not a change has occurred in at least one of the sets of screen coordinates where the active window 41 is drawn and the sets of screen coordinates where the cursor 42 is drawn.

The target area determining module 52, which has a resolution receiving module 55, a coordinates receiving module 56, and a target area information receiving module 57, receives information of a target area based on sets of screen coordinates where the active window 41 and the cursor 42 are drawn and a current display resolution.

The resolution receiving module 56 receives a current display resolution of the display screen. This information can be received from the operating system.

The coordinates receiving module 56 calculates sets of screen coordinates where the active window 41 is drawn based on screen coordinates of the origin of the client coordinate system of the active window 41 and a size of the active window 41 that are received from the operating system. The coordinates receiving module 56 receives sets of screen coordinates where the cursor 42 is drawn from the operating system.

The target area information receiving module 57 receives information of light sources 23 that illuminate screen areas (a target area) to which the sets of screen coordinates where the active window 41 is drawn and the sets of screen coordinates where the cursor 42 is drawn belong at the current display resolution by searching the storage unit 31 based on the current resolution.

To increase the visibility of the target area that is more important to the user, the luminance controller 53 performs a control so that the light sources 23 for illuminating the target area emit light at first luminance and the light sources 23 for illuminating the other areas emit light at second luminance that is lower than the first luminance.

The end determining module 54 determines whether or not an instruction to the effect that the system should be deactivated has been given by the user via a user interface such as the keyboard 13.

Next, a description will be made of an example process which is executed by the personal computer 10 according to the embodiment.

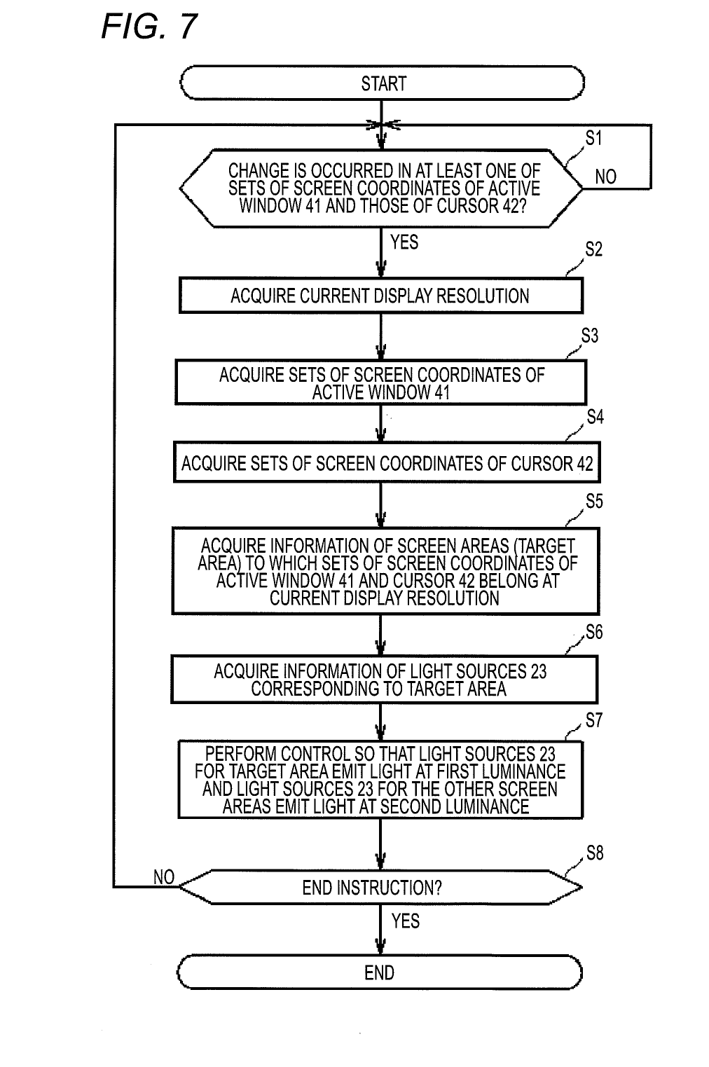

FIG. 7 is a flowchart of a procedure according to which the main controller 33 controls the luminance for each screen area while securing high convenience of the user by keeping the visibility high in a target area.

This procedure is started when the operating system is activated. It is assumed that groups of sets of screen coordinates, areas of the display screen, and information of the light sources 23 for illuminating the respective screen areas are stored in the storage unit 31 so as to correspond to each display resolution.

First, at step S1, the monitoring module 51 monitors whether or not a change has occurred in at least one of the sets of screen coordinates where the active window 41 is drawn and the sets of screen coordinates where the cursor 42 is drawn. For example, a change occurs in the sets of screen coordinates where the active window 41 is drawn when the active window 41 is generated first on the display screen or its size or position is changed. If such a change has occurred (S1: yes, the process moves to step S2. If no such change has occurred (S1: no), the monitoring module 51 continues the monitoring (step S1).

At step S2, the resolution receiving module 55 receives a current display resolution of the display screen.

At step S3, the coordinates receiving module 56 calculates sets of screen coordinates where the active window 41 is drawn based on the screen coordinates of the origin of the client coordinate system of the active window 41 and a size of the active window 41 that are received from the operating system.

At step S4, the coordinates receiving module 56 also receives sets of screen coordinates where the cursor 42 is drawn from the operating system.

At step S5, the target area information receiving module 57 receives information of screen areas (a target area) to which the sets of screen coordinates where the active window 41 is drawn and the sets of screen coordinates where the cursor 42 is drawn belong at the current display resolution by searching the storage unit 31 based on the current resolution.

At step S6, the target area information receiving module 57 receives information of light sources 23 for illuminating the target area by searching the storage unit 31 based on the information of the target area.

At step S7, to increase the visibility of the target area that is more important to the user, the luminance controller 53 performs a control so that the light sources for illuminating the target area emit light at first luminance and the light sources 23 for illuminating the other areas emit light at second luminance that is lower than the first luminance. For example, where the reference luminance of each light source 23 is set at 200 cd/m² by the user, the first luminance is set equal to the reference luminance of 200 cd/m² and the second luminance is set at 60 cd/m². The visibility of the target area that is more important to the user can thus be increased.

At step S8, the end determining module 54 determines whether or not an instruction to the effect that the system should be deactivated has been given by the user via the user interface such as the keyboard 13. If an end instruction has been given (S8: yes), the process is finished. If an end instruction has not been given yet (S8: no), the process returns to step S1.

The above-described procedure makes it possible to control the luminance for each screen area while securing high convenience of the user by keeping the visibility high in the target area.

The information processing apparatus according to the embodiment can increase the visibility of screen areas where the active window 41 is drawn and a screen area where the cursor 42 is drawn. The active window 41 and the cursor 42 are images that are particularly important to the user. As such, the embodiment can give a higher level of convenience to the user by reliably keeping the visibility high in regions that are more important to the user than in the conventional technique in which illumination light intensity values for the respective screen areas are determined according to luminance data, corresponding to the respective screen areas, of an image to be displayed. The information processing apparatus according to the embodiment can increase the visibility by lowering the illumination luminance in the areas other than a target area. Therefore, the information processing apparatus according to the embodiment can make the power consumption lower than in a case that the illumination luminance is the same over the entire display screen.

Although the embodiment is directed to the case that the display device is the liquid crystal display device, the display device may be an OLED display. In this case, at least groups of sets of screen coordinates, areas of the display screen, and information of set of OLED elements corresponding to the individual screen areas are stored in advance in the storage unit 31 so as to correspond to each display resolution. The term “light sources 23 for illuminating the respective screen areas” should be replaced by “sets of OLED elements constituting the respective screen areas.” Where an OLED display is used as the display device, the display screen can be divided into finer areas (smallest screen area: one OLED element).

The embodiment is directed to the case that to increase the visibility the luminance is controlled so as to be lower in a target area than in the other screen areas. However, it is sufficient to increase the visibility of a target area by making the light emission state of the target area different from that of the other screen areas. For example, a control may be performed so that color display is maintained in a target area whereas black-and-white display is performed in the other screen areas.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, the present invention can also be applied to various information processing apparatus other than the notebook personal computer as described in the embodiment, the various information processing apparatus being capable of controlling the illumination light intensity for each of divisional areas of the display screen of a display device.

In the embodiment of the invention, the steps of the flowchart of FIG. 7 are executed in the time-series order as shown. However, the invention is not limited to such a case and part of the steps may be executed parallel or individually.

What is claimed is:

1. An information processing apparatus comprising:
a display device comprising a display screen divided into a plurality of areas, each area comprising a luminance;
a target area determining module configured to determine, as a target area, a first group of areas comprising a drawing region comprising at least one of an active window and a cursor; and
a luminance controller configured to cause the target area to have a first luminance and a second group of areas to have a second luminance that is lower than the first luminance.

2. The apparatus of claim 1,
wherein the display device is configured to display an image on the display screen at plural display resolutions,
wherein the apparatus further comprises:
a storage module configured to store a correspondence table between groups of sets of screen coordinates and areas of the display screen for the display resolutions of the display screen, and
wherein the target area determining module is configured to determine a target area by receiving a current display resolution of the display screen and sets of screen coordinates and determining areas comprising the sets of screen coordinates at the current display resolution by searching the storage module.

3. The apparatus of claim 2,
wherein sets of screen coordinates in the active window are determined based on coordinate data indicating a point in the active window and data indicating a size of the active window.

4. The apparatus of claim 3 further comprising:
a monitoring module configured to monitor whether a change has occurred in the sets of screen coordinates,
wherein the target area determining module is configured to re-determine a target area using new sets of screen coordinates when the monitoring module detects that the change is occurred.

5. The apparatus of claim 3,
wherein the display device comprises:
a liquid crystal display panel comprising the display screen; and
a plurality of light sources configured to illuminate the areas of the display screen from behind,
wherein a correspondence table among groups of sets of screen coordinates, areas of the display screen, and the light sources are stored in the storage module for the display resolutions,
wherein the target area determining module is configured to receive a current display resolution and sets of screen coordinates, to determine areas comprising the sets of screen coordinates at the current display resolution by searching the storage module, and to receive information of the light sources for illuminating the determined areas from the storage module, and
wherein the luminance controller is configured to control the luminance values of the areas by controlling emission luminance values of the light sources in such a manner that first light sources for illuminating the target area are configured to emit light at a first luminance and light sources for illuminating the second group of areas are configured to emit light at a second luminance that is lower than the first luminance.

6. A method for controlling luminance of a display screen for areas in the display screen, the method comprising:
determining, as a target area, a first group of areas comprising a drawing region comprising at least one of an active window and a cursor; and
causing the target area to have a first luminance and a second group of areas to have a second luminance that is lower than the first luminance.

7. The method of claim 6 further comprising:
storing a correspondence table between groups of sets of screen coordinates and areas of the display screen for the display resolutions of the display screen in a storage module, and
wherein the target area information is received by:
receiving a current display resolution of the display screen; and
receiving information of a target area comprising sets of screen coordinates at the current display resolution.

8. The method of claim 6 further comprising:
monitoring whether a change has occurred in the sets of screen coordinates, and
wherein the target area information is received by re-receiving information of a target area using new sets of screen coordinates when the change in the sets of screen coordinates is detected.
